(19) United States
(12) Patent Application Publication
(10) Pub. No.: US 2009/0109890 A1
(43) Pub. Date: Apr. 30, 2009

(54) ENHANCED WIMAX MBS SERVICE ON SEPARATE CARRIER FREQUENCY

(76) Inventors: Jerry Chow, San Diego, CA (US); Tricci So, San Diego, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/253,880

(22) Filed: Oct. 17, 2008

Related U.S. Application Data
(60) Provisional application No. 60/981,448, filed on Oct. 19, 2007.

(51) Int. Cl. H04H 20/71

(52) U.S. Cl. 370/312

(57) ABSTRACT

A system and method for supporting multicast and broadcast service (MBS) on one or more separate carrier frequencies are provided. The system includes carrier frequency information to indicate that data in an MBS zone resides on a separate carrier, and to direct the subscriber stations to receive MBS data on the separate carrier. The method comprises establishing an MBS MAC connection between a subscriber station and a base station in a MBS zone, processing carrier frequency information to determine whether data associated with the MBS zone resides on a separate carrier, and if so, transmitting the MBS data on the separate carrier.

### RELATED PATENT APPLICATIONS

This application claims benefit of priority under 35 U.S.C. 119(e) to Provisional Application No. 60/981,448, entitled “Enhanced WiMAX MBS Service on Separate Carrier Frequency”, filed Oct. 19, 2007, which is incorporated by reference herein in its entirety.

### BACKGROUND OF THE INVENTION

1. Field of the Invention

This invention relates to wireless networks, and more particularly, to a system and method for providing a multicast and broadcast service (MBS) in a WiMAX network.

2. Discussion of Related Technology

The support of multicast and broadcast services (MBS) is emerging as a major new feature in broadband wireless standards, such as IEEE 802.16/WiMAX. The latest version of the IEEE 802.16 standard, which includes the 802.16e amendment and is referred to as ‘the 802.16e standard’ or simply as ‘the standard’ herein, has introduced support for multicast and broadcast services (MBS) in its air interface specification. However, operation is limited to placing the traffic for MBS on the same carrier frequency as all other traffic such as system control traffic and unicast user traffic.

While the current support for MBS in the 802.16e standard is sufficient to provide basic service, it imposes some limitations that make it less than ideal as a general solution. First, for other than single-frequency (frequency reuse factor=1) deployments, the over-the-air transfer of MBS traffic cannot benefit significantly from the spatial macro-diversity gain. When data are transmitted simultaneously over a common carrier frequency from multiple Base Stations (BS), the throughout performance of transmitted data improves; and this is referred to as spatial macro-diversity gain. Since it is quite common for the same MBS traffic, such as for broadcast TV or information services, to be sent from a group of BSs, spatial macro-diversity gain can significantly improve the cell-edge throughput performance of MBS traffic. However, improving cell edge performance for all other traffic, which is typically not common between BSs, is typically achieved by sending them on different frequencies from adjacent BSs. For this reason, deployments with sufficient spectrum may choose to use higher frequency reuse factors (e.g., 3) and send all traffic, including MBS traffic, on different frequencies from adjacent BSs. For these deployments, there is a loss of throughput performance for MBS traffic since it should be sent on a single frequency to fully benefit from the macro-diversity gain.

Second, there is no mechanism in the standard to grow the available capacity for MBS traffic independently of capacity for other services. This is because the standard currently defines Base Station (BS) operation as operation of any of the available services on a single carrier; this means that the capacity of a BS can only grow by increasing the channel bandwidth of the carrier on which it operates. MBS traffic is specifically downlink centric and as the service grows, the amount of downlink capacity needed to support the requirements for MBS traffic can become quite large, whereas other types of services, such as conversational voice, can have drastically different downlink vs. uplink requirements. Therefore, it is highly desirable to address capacity growth for MBS traffic independently from other traffic.

Introducing support for carrying MBS traffic on a separate dedicated carrier frequency can overcome the two issues noted above. In the first case where traffic for services other than MBS over multiple BSs is deployed with a higher order frequency reuse (greater than 1), the MBS traffic can reside on a separate dedicated carrier located at one frequency across the multiple BSs (i.e. with a frequency reuse factor of 1). Coupled with synchronized data burst transmissions across the BSs, operating on the single frequency for MBS traffic allows the MBS transmissions to benefit from spatial macro-diversity. In the second case, provisioning one or more dedicated carriers for MBS traffic allows the full carrier to be allocated for downlink to carry the MBS traffic, and thus, decouples the capacity growth requirements for MBS from impacting how the default carrier is used for other traffic.

The 802.16e standard does not provide support for the provisioning of MBS traffic meant to be sent over multiple BSs onto one or more separate dedicated carriers. Proposed modifications to protocol behavior and signaling in the standard in order to add such support is described herein.

The standard defines a specific mode of multicast and broadcast operation where the same MBS traffic is sent simultaneously from a group of BSs. This mode of MBS operation is referred to as multi-BS MBS and this grouping of BSs is called an MBS Zone. The synchronized simultaneous transmission of the same MBS traffic from the BSs in an MBS Zone on a single carrier frequency provides the performance benefits gained via spatial macro-diversity as mentioned earlier.

A subscriber station (SS) that wishes to start reception of particular MBS content over the air interface does so by setting up an MBS Media Access Control (MAC) connection with its serving BS. During the connection setup procedure, the SS is assigned the ID of an MBS MAC connection (known as a Multicast Connection ID, or MCID) to be used for reception of the subscribed content within a specific MBS Zone, as identified by an MBS Zone ID, if the connection is identified as operating in multi-BS MBS mode.

MBS traffic signals for multi-BS MBS connections are sent from the BS as data bursts within major time partitions in the downlink (DL) part of the MAC frame. These time partitions of the frame are referred to as permutation zones as they are distinguished by how subcarriers of the Orthogonal Frequency Division Multiplexed (OFDM) signal are distributed and grouped into subchannels. In another words, an MBS permutation zone is essentially a time partition within the frames that contains MBS data. There are one or more MBS data bursts in a permutation zone, and one or more MAC Protocol Data Units (PDUs) in an MBS data burst.

As defined by the standard when operating with the OFDM Access (OFDMA) physical layer, the BSs transmit resource allocation information to the MSs through Media Access Protocol (MAP) messages that reside at the beginning of the downlink part of the frame. The MAP message used for transmitting downlink resource allocation information is the downlink-MAP (DL-MAP) message. A MAP message includes various information elements (IE) that contain MAC frame control information. In particular, an MBS_MAP_IE may be present in the DL MAP message of a frame that specifies where an MBS permutation zone (or MBS data) starts within the frame.

The MBS_MAP_IE specifies the starting point of an MBS permutation zone. The exact details of the MBS permutation zone, including the structure, modulation and coding of MAC data bursts within the MBS permutation zone, are described in an MBS MAP message. If present, an MBS MAP message always resides as the first data burst within an MBS permutation zone. The MBS MAP message contains IEs that describe the individual MBS data bursts that are present in MAC frames that are 2 to 5 frames in the future from the frame that contains the MBS MAP message itself.

The current method of directing an SS to the applicable MBS data bursts in an MBS permutation zone is illustrated in FIG. 1. As shown in FIG. 1, a plurality of successive frames 101, 102, 103, 104 . . . and 109 are sent by the BSs located in an MBS zone. When an SS has successfully established a specific multi-BS MBS MAC connection, it begins searching the DL MAP messages of those successive frames until it finds the first MBS_MAP_IE that describes the location of the next MBS permutation zone for the MBS Zone that the MBS MAC connection belongs to. The beginning of that MBS permutation zone should contain an MBS MAP message. For example, in FIG. 1, the DL MAP message of frame 101 contains an MBS_MAP_IE 111, which describes the location of an MBS permutation zone 100. The beginning of the MBS permutation zone 100 contains MBS MAP message 120.

On finding an MBS MAP message that contains a data burst allocation for an applicable MBS connection, the SS is provided sufficient information to locate, demodulate and decode the MBS data burst, and in addition, to locate the next occurrence of an MBS MAP message containing the next occurrence of a data burst for the MBS connection. In FIG. 1, MBS MAP message 120 contains three IEs 121, 122, and 123. These IEs can be MBS_DATA_IE, Extended_MBS_Data_IE, or MBS_Data_Time_Diversity_ID. IEs 121, 122, and 123 contain the addresses of MBS data bursts 131, 133, and 134, respectively. IE 121 also contains the address of the next MBS MAP Message 130 for the same MBS zone in frame 109 for the MBS MAC connections which the IE indicates MBS data for. Although not shown, IEs 122 and 123 also contain addresses of the next MBS MAP message(s) for the MBS MAC connections which these IEs indicate data for. Thus, once the SS finds MBS MAP message 120, it knows how to retrieve MBS data bursts 131, 133, and 134. In addition, the SS also knows how to find the next MBS MAP message 130. This latter feature (that is, the chaining from an MBS MAP message to the next MBS MAP message(s) pertaining to the same MBS connections) enables efficient power saving operation when the SS is not otherwise active except to occasionally receive applicable MBS content because the SS is not required to continually monitor the DL MAP message of each frame searching for the next MBS MAP message for an applicable MBS connection.

As discussed above, the standard does not provide support for the provisioning of MBS traffic meant to be sent over multiple BSs onto one or more separate dedicated carriers. Therefore, there is a need for an improved method and system of supporting MBS service on a separate carrier frequency that maximizes reuse of the existing framework and protocols of the MBS service.

### SUMMARY OF THE INVENTION

Embodiments of the present invention are directed to a system and method for supporting multicast and broadcast service (MBS) on one or more separate carrier frequencies. The current standard is extended to allow an MBS zone to reside on a separate carrier frequency. This means that an MBS Zone may be associated with a separate carrier frequency, and carrier frequency information is provided to indicate that MBS data resides on a separate carrier, and to direct the subscriber stations to receive MBS data on the separate carrier.

The carrier frequency information may be included in an information element (MBS_MAP_IE) of a downlink channel MAP message (DL-MAP) that initially directs a subscriber station (SS) to data in an MBS zone. It can also be included in an MBS zone identifier assignment or an MBS zone descriptor TLV.

To receive MBS data on the separate carrier, a subscriber station first establishes an MBS MAC connection with a base station in an MBS zone, and then processes carrier frequency information to determine whether data associated with the MBS zone resides on a separate carrier. If so, the subscriber station switches to the separate carrier, and receives MBS data on the separate carrier.

A method is provided to allow sufficient time for a subscriber station (SS) to switch to a separate carrier to receive MBS data. The subscriber station is not required to switch back and forth between the normal carrier and the separate carrier in search of MBS data. Another method is provided to define a common understanding between SS and BS as to when and for how long the SS will be operating on the separate MBS carrier frequency (and thus, not available for other types of data transfers on the normal operating carrier frequency).

### BRIEF DESCRIPTION OF THE DRAWINGS

FIG. 1 illustrates a conventional MBS data burst allocation method according to the 802.16e standard.

FIGS. 2A and 2B illustrate flow charts for an exemplary MBS operation on a separate carrier frequency according to one embodiment of the present invention.

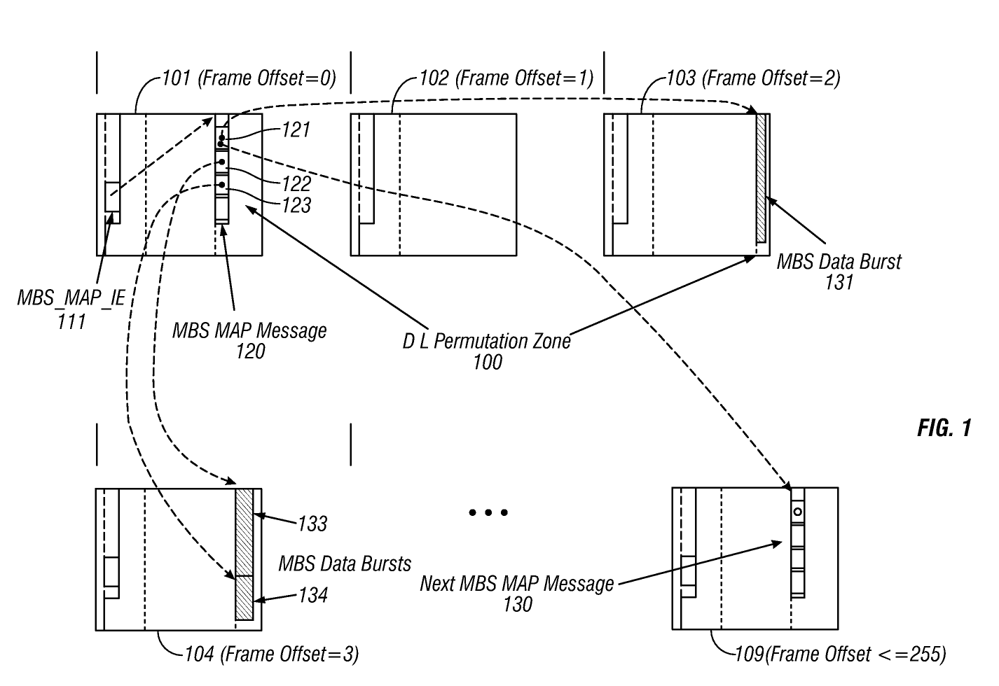

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

Although embodiments of the present invention are described herein in terms of a WiMAX network, it should be understood that the present invention is not limited to this application, but is generally applicable to any wireless network.

Embodiments of the present invention are directed to a system and method for supporting multicast and broadcast service (MBS) on one or more separate carrier frequencies.

In one embodiment of the present invention, an SS is directed to a separate carrier frequency to receive relevant MBS data. In this embodiment, all MBS data for a particular MBS Zone resides on a specific carrier frequency, and each multi-BS MBS connection is flexibly associated with a specific MBS Zone based on criteria deemed suitable by the network. The question of which carrier frequency the MBS data should be sent on for a particular MBS connection is one factor to be considered in the MBS Zone assignment criteria.

Given the mechanisms and procedures in the standard that allow an SS to find relevant MBS data allocations for its active MBS connections, the assignment of carrier frequency for MBS data may be on an MBS zone basis. There exemplary embodiments of the invention are described below.

### Embodiment 1

Add 3 new fields to the MBS_MAP_IE in a DL MAP message or introduce a new IE or signaling element that is equivalent to MBS_MAP_IE in DL MAP. Unless explicitly stated otherwise, use of the term MBS_MAP_IE in subsequent descriptions relating to this Embodiment 1 applies to either the modified existing MBS_MAP_IE or an equivalent new IE or signaling element. The MBS_MAP_IE is the IE that directs an SS to the next MBS permutation zone allocation for a specific MBS Zone.

‘Allocation on Separate Carrier’ flag: A value of ‘1’ indicates that more fields are included to specify the carrier frequency and bandwidth of the separate carrier on which the MBS data resides; whereas a value of ‘0’ indicates the MBS permutation zone allocation is on the normal operating carrier (since this is where the MBS_MAP_IE is sent).

‘MBS Carrier Frequency’: This field specifies the center frequency of the separate carrier for MBS data. This field is only included if the ‘Allocation on Separate Carrier’ flag is set to ‘1’.

‘MBS Carrier Bandwidth’: This field specifies the channel bandwidth for the separate carrier to allow the bandwidth to be different than the normal operating carrier. This field is only included if the ‘Allocation on Separate Carrier’ flag is set to ‘1’.

In this embodiment, these fields are situated within the format of the MBS_MAP_IE such that their relevance would be only for a multi-BS MBS permutation zone allocation.

One advantage of this embodiment is that it provides flexibility and potentially allows the carrier frequency to be changed dynamically while MBS connections are active.

One potential disadvantage of this embodiment is that it introduces unnecessary protocol overhead to the MBS_MAP_IE if the ability to change the carrier frequency for an MBS Zone dynamically is not required. The MBS_MAP_IE is sent periodically and any static information included presents unnecessary protocol overhead.

### Embodiment 2

Specify the association of a separate carrier frequency to an MBS Zone during MBS connection setup for multi-BS MBS. The MBS Zone assignment for the connection is conveyed to the SS at that time.

One way to implement this embodiment is to modify the existing ‘MBS Zone Identifier Assignment’ Type-Length-Value element (TLV) to include the 3 new fields (i.e. ‘Allocation on Separate Carrier’, ‘MBS Carrier Frequency’ and ‘MBS Carrier Bandwidth’) described in Embodiment 1 above or to introduce a new equivalent TLV element that includes these 3 new fields. The modified or new TLV can be carried in the Dynamic Service Addition Request (DSA-REQ) or Dynamic Service Addition Response (DSA-RSP) MAC management message sent during MBS MAC connection setup.

One advantage of this embodiment is that it is more efficient in terms of reduced over-the-air protocol overhead as compared to Embodiment 1, if the assignment of MBS Zone to a carrier frequency can be considered static since MAC connection setup operations are expected to occur much less often than MBS_MAP_IE.

One potential disadvantage of this embodiment is that it may still introduce more overhead than necessary if the assignment of MBS Zone to a carrier frequency can be considered static.

### Embodiment 3

Specify the association of a separate carrier frequency to an MBS Zone as system broadcast information.

Currently a list of MBS Zone Identifiers supported by a particular BS is advertised as system broadcast information in the Downlink Channel Descriptor (DCD) MAC management message. To support the advertisement of a separate carrier frequency being associated with a particular MBS Zone, a new list to describe MBS Zones supported by a BS can be introduced where each supported MBS Zone is described by an ‘MBS Zone Descriptor’ TLV instead of simply an MBS Zone Identifier. The information included in this ‘MBS Zone Descriptor’ TLV would be identical to the extended ‘MBS Zone Identifier Assignment’ TLV as described in Embodiment 2.

One advantage of this embodiment is that it is more efficient in terms of reduced over-the-air protocol overhead as compared to Embodiment 1, if the assignment of MBS Zone to a carrier frequency can be considered static since system broadcast information, although sent periodically, should be sent less often than MBS_MAP_IE. This embodiment may be more efficient than Embodiment 2 but this depends on how often MBS MAC connections are set up versus how often system broadcast information is sent.

One potential disadvantage of this embodiment is that it provides more information to an SS searching for service than necessary (that is, it is not necessary for SS to know the frequency on which data for MBS Zone is sent before choosing a BS for service).

Any of the above embodiments can solve the problem of associating a separate carrier frequency to an MBS Zone. If this association can be considered static (that is, is provisioned from a system perspective), then either Embodiments 2 or Embodiment 3 should be chosen as they would incur less protocol overhead than Embodiment 1. Whether Embodiment 2 or 3 results in the least overhead depends on system operating environmental factors, such as the expected rate of arrival of users activating MBS service that requires multi-BS MBS transport vs. the required rate of system broadcast information in order to meet latency requirements for new users entering the network. An additional consideration in this regard is that the information for all MBS Zones would be repeated for each transmission of system broadcast information with Embodiment 3 whereas with Embodiment 2, only the information for a single MBS Zone would be sent for each multi-BS MBS connection being established.

In one embodiment, the present invention addresses when an SS needs to switch to a separate carrier to receive MBS data. In this embodiment, there are two cases to consider. The straightforward case is when an SS has successfully read the first MBS MAP message for relevant MBS MAC connections for an MBS Zone for which MBS data is transmitted on a separate carrier. As described above, once this has been achieved, the SS is able to determine the location of relevant MBS data bursts as well as the location of the next MBS MAP message(s) for relevant MBS connections from the current MBS MAP message. Also, in order to facilitate operation of MBS on the separate carrier while an SS is in Idle Mode, it is advantageous to send the MBS MAP message on the same carrier as the MBS data (so that the MS is not required to do any carrier frequency changes to receive each set of MBS data associated with an MBS MAP message, which would not be the case if the MBS MAP message were sent on the normal operating carrier while the MBS data resided on a separate carrier and so that the reception performance of the MBS MAP message can benefit from macro-diversity transmission if macro-diversity is implemented for the separate carrier carrying the MBS traffic whereas macro-diversity is not implemented on the normal operating carrier). Therefore, the BS can operate on the premise that an SS will not be available for a timeframe starting from somewhat before the frame containing an MBS MAP message that describe data bursts with PDUs from one or more active MBS MAC connections for the SS, and ending somewhat after the frame containing the PDUs of an active MBS MAC connection for the SS which was described by that MBS MAC message. The term ‘somewhat before’ and ‘somewhat after’ in this context refers to time allowance for the SS to change carrier frequency in time to receive the MBS MAP message and in time to receive the Preamble of the next frame back on the normal operating carrier, respectively. Other simpler approaches could also be taken in setting the timeframe on the separate MBS carrier such as by taking it to be the maximum possible time for an instance of an MBS MAP message as allowed by the protocol and applying this common timeframe for all SSs with one or more active MBS MAC connections included in the data bursts described by this MBS MAP message.

The other case that needs to be considered is for an SS that is acquiring or re-acquiring a first MBS MAP message for active MBS MAC connections within an MBS Zone whose data is carried on a separate carrier. As described above, the standard defines the MBS_MAP_IE in the DL MAP for this purpose. For multi-BS MBS support, the MBS_MAP_IE defines the location of the next MBS MAP message for a particular MBS Zone. However, the MBS_MAP_IE does not contain any identification of the MBS MAC connections for which the MBS MAP message provides data allocations. This connection identification information is only contained in the MBS MAP message itself, which is reasonable for protocol overhead efficiency reasons. Therefore, initially as an SS is searching for one or more MBS MAP messages that contain an initial allocation for each of its active MBS MAC connections, it may read one or more MBS MAP messages that do not contain data for any of its active MBS connections. While this does not present any overhead when the MBS MAP message is on the normal operating carrier, it does result in undesired toggling to the separate MBS carrier just to find that the MBS MAP message does not apply to the SS if the MBS MAP message is located there. This issue may be solved in a number of ways.

In one embodiment, the MBS MAC connections, for which an upcoming MBS MAP message on a separate carrier will describe MBS data transmissions, are identified via system control signaling that is broadcast or multicast to SSs on the normal operating carrier. This control signaling is sent sufficiently in advance of the occurrence of the MBS MAP message on the separate carrier so as to allow sufficient time for the SS to switch to and validate synchronization on the separate carrier before the MBS MAP message. In addition to identification of the included MBS MAC connections, this control signaling that announces the upcoming occurrence of the MBS MAP message on a separate carrier would also include information similar to the MBS_MAP_IE, such as the MBS Zone identifier, the location of the MBS permutation zone or more generally, the MBS transmission region, for the MBS Zone at the separate carrier, and the modulation and coding scheme applied to the MBS MAP message. This control signaling would also include appropriate time interval information from the occurrence of the control signaling to the occurrence of the MBS MAP message on the separate carrier. This time interval information is in some appropriate time unit that the SS can effectively use to measure the time interval, such as in time unit defined by the frame structure, like numbers of frames or subframes, or to identify a specific time for the MBS MAP message, such the identity of a specific frame or subframe within a frame. The identification of MBS MAC connections in this control signaling can be comprised of a list of MCIDs or some other applicable method of identifying specific MBS content flows for reception, and/or some appropriate summarization or grouping of MBS MAC connections.

In another embodiment of the present invention, any MBS MAP message that is sent on a separate carrier and that is pointed to by an MBS_MAP_IE is also sent on the normal operating carrier. In this embodiment, the same MBS MAP message is sent on both the normal operating carrier and the separate MBS carrier in the same unit of the frame structure that defines the scope of applicability of the MBS_MAP_IE (for example, in the 802.16e standard, this unit is a MAC frame). In one embodiment, the time offset to the location of the MBS MAP message within the frame structure unit at the normal operating carrier, as specified by the MBS_MAP_IE, is the same as the offset at the separate carrier, as specified by the MBS MAP message chaining information there; this means that the MBS MAP message is sent in the same location within the frame structure unit at the normal operating carrier and at the separate carrier. In another embodiment, the time offset to the location of the MBS MAP message within the frame structure unit at the normal operating carrier, as specified by the MBS_MAP_IE, is different from the offset at the separate carrier, as specified by the MBS MAP message chaining information there; this means that the MBS MAP message is sent in a different location within the frame structure unit at the normal operating carrier and at the separate carrier. Furthermore, in one embodiment, the same modulation and coding, as defined by the MBS_MAP_IE, is applied to the MBS MAP message sent on the normal operating carrier and to the same MBS MAP message sent on the separate carrier, as specified by the MBS MAP message chaining information there. In another embodiment, the modulation and coding that is applied to the MBS MAP message sent on the normal operating carrier, as defined by the MBS_MAP_IE, is different from the modulation and coding that is applied to the same MBS MAP message sent on the separate carrier, as is specified by the MBS MAP message chaining information there. Those MBS MAP messages that are not pointed to by an MBS_MAP_IE are only sent on the separate MBS carrier.

The implication for the embodiment in which the MBS MAP message is sent on both the normal operating carrier and the separate carrier when pointed to by an MBS_MAP_IE is that for the MBS MAP acquisition case, the initial switch to the separate MBS carrier occurs after reading the copy of the MBS MAP message being sent on the normal operating carrier. This carrier switch needs to complete successfully before the occurrence of the first frame containing MBS data as specified by MBS data burst descriptions in the MBS MAP message. The standard forces at least a 1 frame gap from the end of the frame that contains MBS MAP message to the start of the frame that can contain the specified MBS data bursts, and in addition, supports some further configurability in adding a greater offset in the order of 0 to 3 frames. Since the standard supports a smallest frame size of 2 milliseconds with typical frame sizes being 5 milliseconds long, the current 1-frame gap between MBS MAP message and MBS data is, for the most part, sufficient to support the required change in carrier frequency. The standard can also be configured to support a gap up to four frames. If an even larger gap is required, only a small definition change to either make the minimum gap larger or to allow a greater range of configurability of a further frame offset would be necessary.

For SSs that can only receive on one carrier frequency at a time, there needs to be an understanding between the BS and the SS as to when the SS is receiving from a separate MBS carrier frequency and when the SS is available for other operations on the normal operating carrier. Ideally, this coordination would be done while minimizing any control signaling.

When the SS is in Idle Mode, there is no issue since there is already coordination of time that the SS is available and unavailable for paging. Therefore, it is simply a responsibility of the SS to ensure that it returns to the normal operating frequency in time to be available during its assigned paging interval, or available to perform other Idle Mode control operations with the BS, such as relevant location updates. It is the responsibility of the network side to ensure that SS paging intervals do not overlap with times that the SS is required to be on the separate carrier in order to receive relevant MBS data.

When the SS is in an active mode, it is normally expected to be available for communications with the BS at the normal operating carrier unless it has pre-negotiated certain intervals to be unavailable, such as for handover scanning or for periods of ‘sleep’. Changing of carrier frequencies to receive MBS data would constitute another type of unavailable interval for an SS.

To minimize control signaling in order to coordinate this time that an SS is unavailable at the normal operating carrier due to reception of MBS data at a separate carrier, a method of coordination involving no additional control signaling is highly preferred. This type of no-overhead coordination is possible in this case because the maximum interval that the SS is expected to be available at the separate carrier frequency for the reception of MBS data can be determined based on the MBS data burst allocation protocol.

As established as part of the solution in earlier sections, the BS is aware of which MBS MAC connection(s) within which MBS Zone(s) the SS is active on. Based on this and knowing which MBS connections are specified as containing data via the MBS MAP message, the BS can simply expect the SS to be unavailable for the duration of the time the SS should be reading MBS content on the other carrier. Therefore, coordination of the time during which the SS is receiving MBS MAP and data on a separate carrier is accomplished with no further protocol changes in the standard (except those already discussed in previous sections above).

In addition, it is possible to support higher end SSs that can receive from 2 (or conceptually more) carrier frequencies simultaneously. If such capability is known by the BS/network, it can make use of this knowledge to understand that service at the normal operating carrier can continue while the SS is also receiving MBS data on the separate carrier. For this type of SS, there is no unavailable period while the SS is receiving at the other carrier. This type of capability distinction can be added to the capabilities identification and negotiation stage during SS network entry, such as in the Subscriber Station Basic Capability Request (SBC-REQ) and Subscriber Station Basic Capability Response (SBC-RSP) MAC management message exchange.

One of the strengths of the way the standard defines MBS operation is that it efficiently supports an SS entering Idle Mode while still actively receiving MBS content (i.e. entering essentially a listen, or receive, only mode). As described above, the location of the next MBS MAP message for one or more MCIDs is provided to the SS from the current MBS MAP message. This mechanism is effective in helping an SS to operate with extended battery life. The ‘chaining’ of MBS MAP messages eliminates the need for the SS to continuously monitor the DL MAP in order to search for the next MBS_MAP_IE.

In one embodiment, the present invention maintains this efficiency of MBS operation with MBS data transmission on a separate carrier by specifying that, in addition to the MBS data bursts, the MBS MAP message are also sent on the separate carrier. Doing this allows the SS to remain on the separate MBS carrier for the majority of the time when the SS is otherwise in Idle Mode.

The present invention supports MBS operation on a separate carrier frequency while minimizing the necessary changes to the standard. In accordance with one embodiment of the present invention, the BS concept is extended to include one or more radio channels (carrier frequencies) used exclusively or partially to carry MBS traffic (i.e. multiple radio channels controlled by a common MAC). Except the MBS MAP messages, all other MAC control and data traffic for all other services continues to be carried on the normal operating carrier frequency.

In accordance with one embodiment of the present invention, the MAC framing on the separate MBS carrier has the following attributes: its length of frame, frame boundary, and frame number are aligned with that at the normal operating carrier.

In one embodiment, the separate carrier has its own synchronization channel (such as a Preamble) and any cell identification information conveyed by the synchronization channel is the same as for the normal operating carrier; typically this means that the synchronization channel is assigned synchronization codes that are the same as that assigned for the normal operating carrier. In another embodiment, the separate carrier shares the same synchronization channel as the normal operating carrier.

Each frame retains basic broadcast frame structure configuration information, such as that contained in the Frame Control Header (FCH) of frames as defined by the standard. The same type of standardized content applies to the separate carrier as that applies to the normal operating carrier. In general, the entire carrier should be always operated as a single segment, or frequency partition.

Each frame contains a minimal amount of broadcast frame control signaling information, such as the mandatory fields (PHY Synchronization Field, Base Station ID, and No. of OFDMA Symbols for DL Subframe) in a DL MAP of the standard. If the separate carrier is dedicated to MBS transmissions, the carrier is configured to specify downlink (DL) only operation in the entire frame.

Besides a minimal number of OFDMA symbol times required at the beginning of the frame for the minimal system broadcast information, such as that contained in the FCH and minimal DL-MAP of the standard, the rest of the frame can be treated as one or more MBS permutation zones for MBS data.

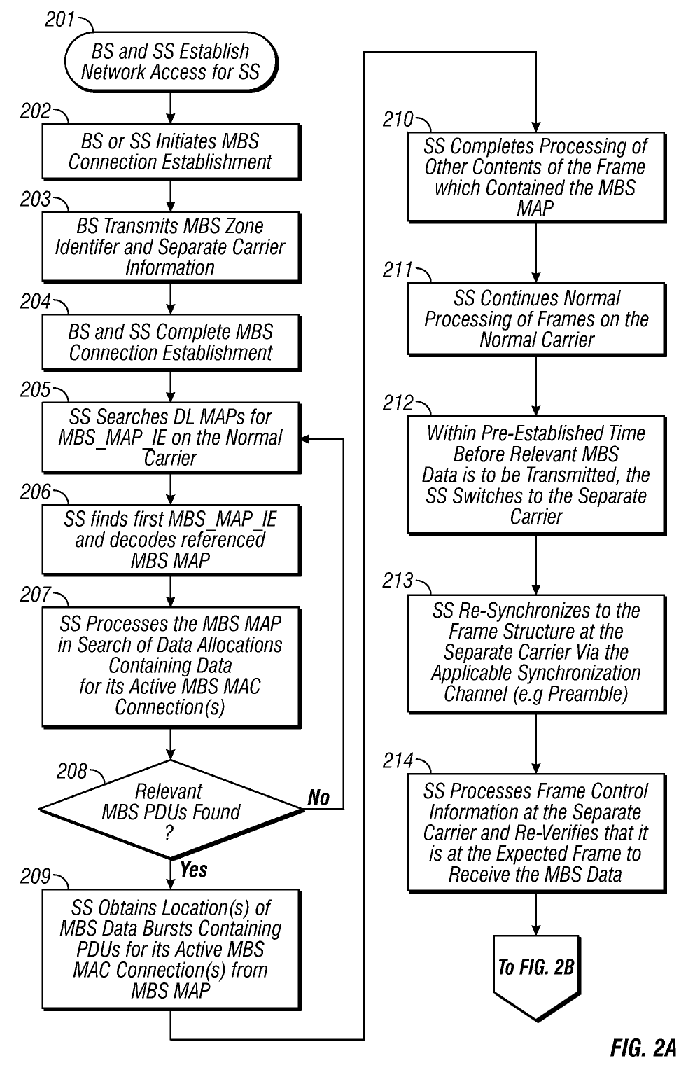

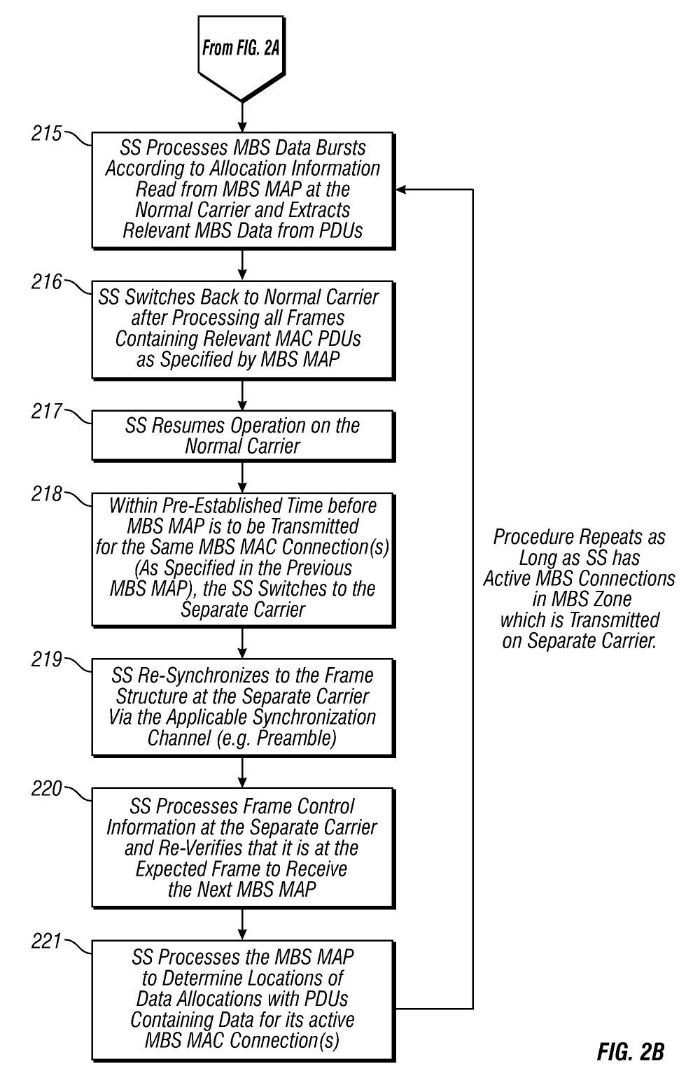

FIG. 2 is a flow chart for an exemplary MBS operation on a separate carrier frequency according to one embodiment of the present invention. The steps for an SS to activate an MBS MAC connection and start up MBS data reception are summarized as follows. In this embodiment, the association of carrier frequency to MBS Zone is done in accordance with Embodiment 2 described above.

In step 201, an SS that supports MBS service on a separate carrier establishes network access via a BS.

In step 202, the SS decides to establish access to a particular MBS service and initiates MBS connection establishment.

The BS/network supports this MBS service via multi-BS MBS and has placed the MBS data on a separate carrier. In step 203, the BS/network responds to the SS request with assignment of an MBS Zone identifier along with an indication that the MBS Zone's data is on a separate carrier and provides the MBS carrier frequency and bandwidth. The SS saves these separate-carrier parameters associated with the MBS Zone for later use.

In step 204, the MBS connection establishment completes successfully according to the standard connection setup protocol.

In step 205, the SS searches the DL MAP messages in successive frames on the normal operating carrier for MBS_MAP_IE that contains a pointer to an MBS MAP message for the assigned MBS Zone.

In step 206, according to one embodiment of the present invention, on finding the first such MBS_MAP_IE, the SS decodes the MBS MAP message located in the data burst region at the given OFDMA symbol offset as specified by the MBS_MAP_IE. Even though the SS knows MBS MAP messages and data bursts for this MBS Zone are provided on a separate carrier, it also knows that the MBS_MAP_IE points to a copy of the MBS MAP message provided in the same frame on the normal operating carrier (i.e., within the same frame as the MBS_MAP_IE).

In step 207, the SS processes the MBS MAP message in search of the presence of any MBS data burst allocations containing MAC PDUs belonging to any of its active MBS connections.

In step 208, the SS determines whether it has found the presence of any MBS data allocations containing MAC PDUs belonging to any of its active MBS connections. If not, the SS does not switch to the separate MBS carrier as a result of the processing of this MBS MAP message, and repeats Steps 205-208.

If the SS finds an MBS data burst allocation for the MCID(s) of its active MBS connection(s) within the specific MBS Zone associated with the MBS MAP message, the SS obtains the address/location of the MBS data burst(s) in step 209. According to the MBS_DATA_IE within the MBS MAP message, the MBS data burst containing the MAC PDU for the MCID is located at a frame offset of 2 (or alternatively, 3, 4, or 5) from the current frame in accordance with one embodiment of the invention (a value of 2 is the minimum frame offset).

In step 210, the SS completes processing of the other content of the current frame in case it contains any other MAC PDUs or signaling applicable to the SS.

In step 211, the SS continues normal processing of frames on the normal operating carrier if it determines that it is not yet time to switch to the separate carrier in order to receive relevant MBS data.

In step 212, after completing any outstanding uplink transmissions in the current frame and determining that it is now within a pre-established time before the relevant MBS data is to be received on the separate carrier (where this pre-established time is an interval in advance of the relevant MBS data transmission which has been previously agreed between the BS and SS in order to allow the SS to switch to the separate carrier), the SS initiates a change of carrier frequency in preparation for MBS data reception from the frame at an offset of 2 (or alternatively 3, 4, or 5).

During the next frame time, the SS completes the change of carrier frequency and begins searching for the applicable synchronization channel, such as a Preamble, of the next frame in step 213.

In step 214, on successfully finding the synchronization channel, such as a Preamble, the SS demodulates/decodes the frame control information, such as the Frame Control Header (FCH) and subsequently, the DL MAP, from the frame; the SS verifies that it is receiving the correct frame by comparing the frame number included in the frame with what the SS expects for the frame at frame offset 2 from the frame in which the MBS MAP message was received.

In step 215, the SS uses the parameters for the MBS data burst that were read from the MBS MAP message to locate the DL data region for the burst, to demodulate/decode the MAC PDUs from that burst, and to extract the pertinent data PDU for the MCID from the PDUs in the data burst.

Supposing there was only one PDU for the MBS MAC connection (as was specified in the previous MBS MAP message), at completion of reception of the current frame, in step 216, the SS initiates a change of frequency back to the normal operating carrier in order to continue its other operations.

In step 217, the SS resumes operation in its normal carrier. From the contents of the previous MBS MAP message, the SS knows in which future frame to expect the next MBS MAP message for its active MBS connection.

Within a pre-established time before the next MBS MAP message for the relevant MBS MAC connections will be transmitted on the separate carrier, such as at the start of the frame immediately before the one which contains the next MBS MAP message, the SS initiates a change of carrier frequency to the MBS carrier in step 218.

The SS completes the change of frequency before the start of the next frame and proceeds to re-synchronize to and process the next frame for the MBS MAP message in steps 219 to 221. The parameters of where in the frame and the size and modulation/coding to use to receive the MBS MAP message were cached from the previous MBS MAP message—these are now used to locate and detect/decode the MBS MAP message.

Processing of the MBS MAP message also provides information to the SS as to which subsequent frame(s) within the next 2 to 5 frames contains data for its pertinent MAC connection(s).

Thereafter, the procedure to receive MBS data from the separate carrier repeats from steps 215 to 221 as the SS processes the subsequent frame(s) to extract pertinent PDUs, initiates a change of frequency back to the normal operating carrier in order to continue its other operations, resumes operation in its normal carrier, and returns to the separate carrier at the next specified time and location (according to the last MBS MAP message) in order to read the next MBS MAP message for the relevant MBS connections.

In accordance with this embodiment of the present invention, the SS receives non-MBS data on a normal operating carrier frequency, and receives MBS data on a separate carrier frequency. The SS is directed to switch to a separate carrier at an optimal time, and is not required to switch back and forth between the normal carrier and the separate carrier in search of MBS data. Furthermore, there is a common understanding between the SS and the BS as to when the SS will be operating on the separate MBS carrier frequency, and when the SS is available for other operation on the normal operating carrier frequency.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for providing a multicast and broadcast service (MBS) in a wireless network, the method comprising
establishing an MBS MAC connection between a subscriber station (SS) and a base station (BS) associated with an MBS zone;
processing carrier frequency information to determine whether MBS data associated with the MBS zone resides on a second carrier that is separate from a first carrier, and if so;
sending the MBS data on said second carrier.

2. The method of claim 1, further comprising sending broadcast frame control information on the first carrier, the broadcast frame control information defines the time and location of a first MBS_MAP message associated with the MBS zone that resides on the second carrier.

3. The method of claim 2, wherein the broadcast frame control information is included in an information element (MBS_MAP_IE) of a downlink channel MAP message (DL-MAP).

4. The method of claim 3, further comprising sending the first MBS_MAP message referenced by the MBS_MAP_IE on both the first carrier and the second carrier;

5. The method of claim 4, wherein the first MBS_MAP message is sent in the same frame and with the same modulation and coding on both the first carrier and the second carrier.

6. The method of claim 4, wherein the first MBS MAP message is sent in the same frame and with different modulation and coding on the first carrier and the second carrier.

7. The method of claim 4, wherein the first MBS MAP message is sent in the same location in the same frame on the first carrier and the second carrier.

8. The method of claim 4, wherein the first MBS MAP message is sent in different locations in the same frame on the first carrier and the second carrier.

9. The method of claim 4, further comprising sending a first MBS data burst referenced by the first MBS_MAP message only on the second carrier;

10. The method of claim 9, further comprising sending a second MBS_MAP message referenced by the first MBS_MAP message only on the second carrier.

11. The method of claim 10, further comprising sending other MBS_MAP messages associated with the MBS zone but not referenced by the MBS_MAP_IE on the second carrier.

12. The method of claim 11, wherein the subscriber station (SS) is not available to communicate with the base station (BS) on the first carrier while receiving MBS_MAP messages and MBS data bursts associated with the MBS zone on the second carrier.

13. The method of claim 12, wherein there exists a gap from the end of the frame containing the first MBS_MAP to the start of the frame containing the first MBS data burst, and the gap encompasses at least one frame.

14. The method of claim 13, wherein the gap encompasses one to four frames.

15. The method of claim 2, wherein the broadcast frame control information is sent sufficiently in advance of the occurrence of the first MBS MAP message so as to allow the SS time for switching to the second carrier.

16. The method of claim 15, wherein the broadcast frame control information contains an MBS Zone identifier.

17. The method of claim 15, wherein the broadcast frame control information includes the location of the MBS transmission region for the MBS Zone at the separate carrier.

18. The method of claim 17, wherein the MBS transmission region is an MBS permutation zone.

19. The method of claim 15, wherein the broadcast frame control information includes the modulation and coding scheme applied to the first MBS MAP message.

20. The method of claim 15, wherein the broadcast frame control information identifies an MBS MAC connection within the MBS Zone having data transmissions allocated at the second carrier.

21. The method of claim 20, wherein the identification is accomplished via a list of MBS MAC connection identifiers.

22. The method of claim 20, wherein the identification is accomplished via summarization of a list of MBS MAC connection identifiers.

23. The method of claim 22, wherein the summarization is accomplished via grouping of MBS MAC connection identifiers into ranges.

24. The method of claim 20, wherein the SS uses information regarding the identified MBS MAC connection to determine if there are any relevant MBS data to be retrieved on the second carrier.

25. The method of claim 1, wherein the wireless network is a WiMAX network.

26. The method of claim 1, wherein the MBS data is sent simultaneously from at least two base stations (BS) on the second carrier.

27. The method of claim 1, wherein the carrier frequency information includes the center frequency of the second carrier.

28. The method of claim 1, wherein the carrier frequency information includes the channel bandwidth of the second carrier.

29. The method of claim 1, wherein the carrier frequency information is included in an information element.

30. The method of claim 29, wherein the information element is included in broadcast control information on the first carrier that indicates the upcoming transmission of MBS data for MBS MAC connections on the second carrier.

31. The method of claim 30, wherein the broadcast control information is an MBS_MAP_IE in a downlink channel MAP message (DL-MAP).

32. The method of claim 30, wherein the carrier frequency information is dynamically changeable within the MBS zone.

33. The method of claim 1, wherein the carrier frequency information is a configurable semi-static attribute of the MBS Zone.

34. The method of claim 33, wherein the carrier frequency information is included in a Type-Length Value element (TLV).

35. The method of claim 32, wherein the TLV is an “MBS Zone Identifier Assignment” TLV.

36. The method of claim 32, wherein the TLV is an “MBS Zone Descriptor” TLV.

37. The method of claim 33, wherein the carrier frequency information is communicated to the SS as broadcast system configuration information

38. The method of claim 37, wherein the broadcast system configuration information is included in a Downlink Channel Descriptor (DCD) MAC management message.

39. The method of claim 38, wherein the DCD MAC management message includes one or more “MBS Zone Identifier Assignment” TLVs containing carrier frequency information.

40. The method of claim 38, wherein the DCD MAC management message includes one or more “MBS Zone Descriptor” TLVs containing carrier frequency information.

41. The method of claim 33, wherein the BS communicates the carrier frequency information to the SS during the signaling message exchange for MBS MAC connection establishment or change.

42. The method of claim 41, wherein the carrier frequency information is contained in an “MBS Zone Identifier Assignment” TLV.

43. The method of claim 41, wherein the carrier frequency information is contained in an “MBS Zone Descriptor” TLV.

44. The method of claim 33, wherein a change in carrier frequency information associated with an MBS Zone is communicated to the SS via a change to broadcast system configuration information.

45. A method for receiving a multicast and broadcast service (MBS) in a wireless network, the method comprising
establishing an MBS MAC connection between a subscriber station (SS) and a base station (BS) associated with a multicast and broadcast service (MBS) zone;
processing carrier frequency information to determine whether MBS data associated with the MBS zone resides on a second carrier that is separate from a first carrier, and if so;
receiving the MBS data on said second carrier.

46. The method of claim 45, further comprising receiving broadcast frame control information on the first carrier, the broadcast frame control information defines the time and location of a first MBS_MAP message associated with the MBS zone that resides on the second carrier.

47. The method of claim 46, wherein the broadcast frame control information is included in an information element (MBS_MAP_IE) of a downlink channel MAP message (DL-MAP).

48. The method of claim 47, further comprising receiving the first MBS_MAP message referenced by the MBS_MAP_IE on the first carrier;

49. The method of claim 48, further comprising switching to the second carrier;

50. The method of claim 49, further comprising receiving a first MBS data burst referenced by the first MBS_MAP message on the second carrier;

51. The method of claim 50, further comprising receiving a second MBS_MAP message referenced by the first MBS_MAP message on the second carrier.

52. The method of claim 51, further comprising receiving other MBS_MAP messages associated with the MBS zone but not referenced by the MBS_MAP_IE on the second carrier.

53. The method of claim 52, wherein the subscriber station (SS) is not available to communicate with the base station (BS) on the first carrier while receiving MBS_MAP messages and MBS data bursts associated with the MBS zone on the second carrier.

54. The method of claim 45, wherein there exists a gap from the end of the frame containing the first MBS_MAP to the start of the frame containing the first MBS data burst, and the gap encompasses at least one frame.

55. The method of claim 54, wherein the gap encompasses one to four frames.

56. The method of claim 46, wherein the broadcast frame control information is sent sufficiently in advance of the occurrence of the first MBS MAP message so as to allow the SS time for switching to the second carrier.

57. The method of claim 56, wherein the broadcast frame control information contains an MBS Zone identifier.

58. The method of claim 56, wherein the broadcast frame control information includes the location of the MBS transmission region for the MBS Zone at the separate carrier.

59. The method of claim 58, wherein the MBS transmission region is an MBS permutation zone.

60. The method of claim 56, wherein the broadcast frame control information includes the modulation and coding scheme applied to the first MBS MAP message.

61. The method of claim 56, wherein the broadcast frame control information identifies an MBS MAC connection within the MBS Zone having data transmissions allocated at the second carrier.

62. The method of claim 61, wherein the identification is accomplished via a list of MBS MAC connection identifiers.

63. The method of claim 61, wherein the identification is accomplished via summarization of a list of MBS MAC connection identifiers.

64. The method of claim 63, wherein the summarization is accomplished via grouping of MBS MAC connection identifiers into ranges.

65. The method of claim 61, wherein the SS uses the MBS MAC connection identification information to determine if there are any relevant MBS data to be retrieved on the second carrier.

66. The method of claim 45, wherein the wireless network is a WiMAX network.

67. The method of claim 45, wherein the MBS data is sent simultaneously from at least two base stations (BS) on the second carrier.

68. The method of claim 45, wherein the carrier frequency information includes the center frequency of the second carrier.

69. The method of claim 45, wherein the carrier frequency information includes the channel bandwidth of the second carrier.

70. The method of claim 45, wherein the carrier frequency information is included in an information element.

71. The method of claim 70, wherein the information element is included in broadcast control information on the first carrier that indicates the upcoming transmission of MBS data for MBS MAC connections on the second carrier.

72. The method of claim 71, wherein the broadcast control information is an MBS_MAP_IE in a downlink channel MAP message (DL-MAP).

73. The method of claim 71, wherein the carrier frequency information is dynamically changeable within the MBS zone.

74. The method of claim 45, wherein the carrier frequency information is a configurable semi-static attribute of the MBS Zone.

75. The method of claim 45, wherein the carrier frequency information is included in a Type-Length Value element (TLV).

76. The method of claim 75, wherein the TLV is an “MBS Zone Identifier Assignment” TLV.

77. The method of claim 75, wherein the TLV is an “MBS Zone Descriptor” TLV.

78. The method of claim 74, wherein the carrier frequency information is communicated to the SS as broadcast system configuration information

79. The method of claim 78, wherein the broadcast system configuration information is included in a Downlink Channel Descriptor (DCD) MAC management message.

80. The method of claim 79, wherein the DCD MAC management message includes one or more “MBS Zone Identifier Assignment” TLVs containing carrier frequency information.

81. The method of claim 79, wherein the DCD MAC management message includes one or more “MBS Zone Descriptor” TLVs containing carrier frequency information.

82. The method of claim 74, wherein the BS communicates the carrier frequency information to the SS during the signaling message exchange for MBS MAC connection establishment or change.

83. The method of claim 82, wherein the carrier frequency information is contained in an “MBS Zone Identifier Assignment” TLV.

84. The method of claim 82, wherein the carrier frequency information is contained in an “MBS Zone Descriptor” TLV.

85. The method of claim 74, wherein a change in carrier frequency information associated with an MBS Zone is communicated to the SS via a change to broadcast system configuration information.

86. A base station (BS) for providing a multicast and broadcast service (MBS) in a wireless network, the base station comprising
a first radio channel; and
a second radio channel having a different carrier frequency;
wherein the second radio channel is used for transmitting control information and MBS data associated with the MBS.

87. The base station of claim 78, wherein the first radio channel and the second radio channel are controlled by a common Media Access Control (“MAC”).

88. The base station of claim 78, wherein the second radio channel is used exclusively for transmitting MBS_MAP messages and MBS data bursts.

89. The base station of claim 78, further comprising means for determining whether the MBS data resides on the second radio channel.

90. The base station of claim 78, further comprising means for determining when a subscriber station (SS) is not available to communicate with the base station (BS) on the first radio channel while communicating with the base station on the second radio channel.

91. The base station of claim 90, wherein the subscriber station (SS) is available to communicate with the base station (BS) on the first radio channel while simultaneously communicating with the base station on the second radio channel.

92. The base station of claim 91, wherein the base station is informed by the SS of its capability to simultaneously communicate on the second radio channel while communicating with the BS on the first radio channel during SS entry into the network.

93. The base station of claim 92, wherein the base station is informed by the SS of the capability via a Subscriber Station Basic Capability Request (SBC-REQ) MAC management message.

94. The base station of claim 93, wherein the base station uses information regarding the capability to continue communications with the SS on the first carrier while SS is also receiving MBS data on the second carrier.

95. The base station of claim 90, wherein the subscriber station (SS) is not available to communicate with the base station (BS) on the first radio channel for a timeframe starting a first period before a first frame containing an MBS MAP message that references data bursts associated with the MBS, and ending a second period after a second frame containing the data bursts associated with the MBS.

96. The base station of claim 95, wherein the first period is from 1 to 4 frames and is at a minimum equal to an SS carrier switching time which is a pre-determined SS capability parameter.

97. The base station of claim 95, wherein the second period is equal to an SS carrier switching time which is a pre-determined SS capability parameter.

98. A subscriber station (SS) for receiving a multicast and broadcast service (MBS) in a wireless network, the base station comprising
a first radio channel; and
a second radio channel having a different carrier frequency;
wherein the second radio channel is used for transmitting control information and MBS data associated with the MBS.

99. The subscriber station of claim 98, wherein the first radio channel and the second radio channel are controlled by a common Media Access Control (“MAC”).

100. The subscriber station of claim 98, wherein the second radio channel is used exclusively for transmitting MBS_MAP messages and MBS data bursts.

101. The subscriber station of claim 98, further comprising means for determining whether the MBS data resides on the second radio channel.

102. The subscriber station of claim 98, wherein the subscriber station can only communicate with a base station on one radio channel at a time.

103. The subscriber station of claim 102, further comprising means for switching to the second radio channel to receive relevant MBS data.

104. The subscriber station of claim 98, wherein the first radio channel and the second radio channel are operable to transmit data simultaneously.

105. The subscriber station of claim 98, wherein the subscriber station has the capability to receive data simultaneously from the first carrier and the second carrier.

106. A method for providing a multicast and broadcast service (MBS) in a wireless network, the method comprising
transmitting a first frame on a first carrier; and
transmitting a second frame containing MBS data on a second carrier that is separate from the first carrier, wherein the first frame and the second frame have the same frame length, the same frame boundary and the same frame number.

107. The method of claim 106, wherein the first frame and the second frame are transmitted simultaneously.

108. The method of claim 106, wherein the first frame and the second frame have the same synchronization channel.

109. The method of claim 108, wherein the synchronization channel is a frame preamble.

110. The method of claim 106, wherein the first frame and the second frame have different synchronization channels.

111. The method of claim 110, wherein the different synchronization channels are frame preambles.

112. The method of claim 110, wherein the different synchronization channels convey the same cell identification information.

113. The method of claim 110, wherein the different synchronization channels are assigned the same synchronization codes.

114. The method of claim 106, wherein the first frame and the second frame have the same frame structure configuration information in a Frame Control Header (FCH).

115. The method of claim 106, wherein the second frame is configured for downlink (DL) only operation.
